(19) United States
(12) Patent Application Publication
(10) Pub. No.: US 2026/0299558 A1
(43) Pub. Date: Oct. 1, 2026

(54) INFORMATION PROCESSING SYSTEM, NON-TRANSITORY COMPUTER READABLE MEDIUM STORING PROGRAM, AND INFORMATION PROCESSING METHOD

(71) Applicant: FUJIFILM Business Innovation Corp., Tokyo (JP)

(72) Inventors: Kazuhiko HORIKAWA, Kanagawa (JP); Ryosuke YONESAKA, Kanagawa (JP); Fumito ITO, Kanagawa (JP); Yuichi ARAKI, Kanagawa (JP)

(73) Assignee: FUJIFILM Business Innovation Corp., Tokyo (JP)

(21) Appl. No.: 19/258,938

(22) Filed: Jul. 3, 2025

(30) Foreign Application Priority Data
Mar. 26, 2025 (JP) 2025-051722

(51) Int. Cl. G05B 19/416

(52) U.S. Cl. CPC G05B 19/416; G05B 2219/37371

(57) ABSTRACT

An information processing system includes a processor configured to: acquire information representing a state of floating paper in a case where air is blown to a side surface of a bundle of the paper and apparatus information related to an apparatus that performs a predetermined process on the paper; and control a flow rate of the air based on the information representing the state and the apparatus information.

### CROSS-REFERENCE TO RELATED APPLICATIONS

This application is based on and claims priority under 35 USC 119 from Japanese Patent Application No. 2025-051722 filed Mar. 26, 2025.

### BACKGROUND

### (i) Technical Field

The present invention relates to an information processing system, a non-transitory computer readable medium storing a program, and an information processing method.

### (ii) Related Art

A technique is known in which air is blown to a paper bundle stacked on a paper tray to float the paper so that an error such as double-feeding of the paper is suppressed. In such a technique, since the error suppression effect is different depending on the flow rate of air blown to the paper bundle, a setting of the flow rate of air is required to improve the error suppression effect. JP2014-47062A discloses that, in a case of determining whether or not a floating state is normal from brightness information obtained by imaging a floating paper, a determination reference is set for each size and type of paper.

### SUMMARY

However, even in a case where a determination reference is provided for each size and type of paper, the error suppression effect is different depending on the state of the image forming apparatus that performs an image forming process. Therefore, a setting of a flow rate in which the state of the image forming apparatus is considered is required to improve the error suppression effect.

Aspects of non-limiting embodiments of the present disclosure relate to an information processing system, a non-transitory computer readable medium storing a program, and an information processing method that can set a flow rate improve error suppression effect as compared with a configuration according to the related art in which a state of the image forming apparatus is not taken into consideration.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing system including a processor configured to: acquire information representing a state of floating paper in a case where air is blown to a side surface of a bundle of the paper and apparatus information related to an apparatus that performs a predetermined process on the paper; and control a flow rate of the air based on the information representing the state and the apparatus information.

### BRIEF DESCRIPTION OF THE DRAWINGS

Exemplary embodiment(s) of the present invention will be described in detail based on the following figures, wherein:

FIG. 1 is a diagram illustrating an example of an overall configuration of an information processing system to which the present exemplary embodiment is applied;

FIG. 2 is a diagram illustrating an example of a hardware configuration of an image processing apparatus configuring the information processing system of FIG. 1;

FIG. 3 is a diagram illustrating an example of a functional configuration of a control unit of the image processing apparatus;

FIG. 4 is a flowchart illustrating an example of a flow of a process of the image processing apparatus;

FIG. 5 is a diagram illustrating a specific example of a paper tray of FIG. 2;

FIGS. 6A to 6C are diagrams illustrating a state in a case where air is blown to a bundle of paper stacked on a paper tray;

FIG. 7 is a diagram illustrating a specific example of a base model generated for each capturing condition;

FIG. 8 is a diagram illustrating a specific example in a case where a flow rate is controlled using the base model;

FIG. 9 is a diagram illustrating a specific example of the base model generated by an image processing apparatus according to a second exemplary embodiment;

FIG. 10 is a diagram illustrating a specific example in a case where the control of the flow rate is performed using one base model generated by the image processing apparatus according to the second exemplary embodiment;

FIG. 11 is a flowchart illustrating an example of a flow of a process until the transport of the paper starts in the process of the image processing apparatus according to the second exemplary embodiment;

FIG. 12 is a diagram illustrating an example of a functional configuration of a control unit of the image processing apparatus according to a third exemplary embodiment;

FIG. 13 is a flowchart illustrating an example of a flow of a process until the transport of the paper starts in the process of the image processing apparatus according to the third exemplary embodiment; and

FIG. 14 is a diagram illustrating a specific example of the position of the paper and the like obtained from an analysis result of a captured image.

### DETAILED DESCRIPTION

Hereinafter, exemplary embodiments of the present invention will be described in detail with reference to the accompanying drawings.

### First Exemplary Embodiment

### Configuration of Information Processing System 1

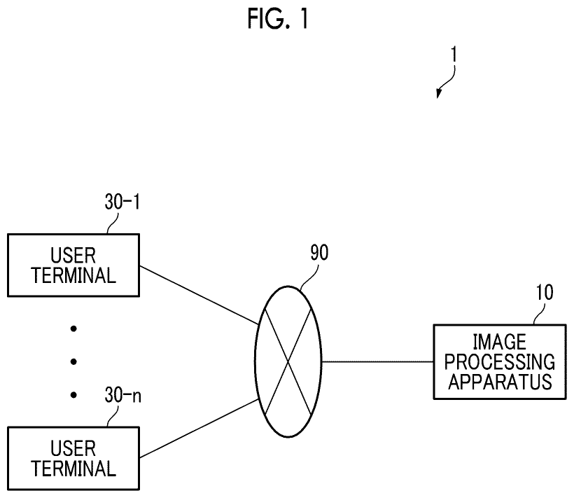

FIG. 1 is a diagram illustrating an example of an overall configuration of an information processing system 1 to which the present exemplary embodiment is applied.

The information processing system 1 is a system that enables a flow rate setting considering a state of an image processing apparatus 10, as a control of an image processing apparatus 10 having a function of blowing air toward a bundle of paper stacked on a paper tray.

The information processing system 1 is configured by connecting the image processing apparatus 10 and user terminals 30-1 to 30-n (n is an integer equal to or greater than 1) via a network 90. The network 90 is, for example, a local area network (LAN) or the Internet. Hereinafter, the user terminals 30-1 to 30-n will be collectively referred to as a “user terminal 30” unless necessary to be individually described.

### Image Processing Apparatus 10

The image processing apparatus 10 performs various types of processes in response to an input operation of a user who uses the information processing system 1. For example, the image processing apparatus 10 can execute a printing process of forming and outputting an image on paper or the like as a recording medium, a copying process of copying and outputting an image of an original document on paper or the like, a reading process of reading an image formed on paper or the like, a process of transmitting an original document by a facsimile, and the like. The image processing apparatus 10 includes, for example, a so-called electrophotographic type multifunction machine that forms a toner image on a printing surface of paper and a so-called inkjet type printer that discharges ink onto a printing surface of paper.

The image processing apparatus 10 has an operation screen as a user interface, and can acquire input information input to the operation screen and execute various types of processes. In addition, the image processing apparatus 10 can acquire various types of information transmitted from the user terminal 30 connected to the image processing apparatus 10 via the network 90 and from the outside, and execute various types of processes. In addition, the image processing apparatus 10 can transmit various types of information to the user terminal 30 and the outside.

For example, the image processing apparatus 10 acquires information representing the state of floating paper in a case where air is blown to a side surface of the bundle of paper stacked on the paper tray. Here, the “side surface of the bundle of paper” refers to a set of edge portions of each of the plurality of paper stacked on the paper tray. In addition, the “information representing the state of floating paper” may be called as, for example, a captured image in which the state of the floating paper is captured (hereinafter, simply referred to as a “captured image”), a numerical value representing the state of the floating paper calculated by a predetermined method, or the like. In the present exemplary embodiment, the captured image is acquired as the information representing the state of the floating paper.

In addition, the image processing apparatus 10 acquires the apparatus information of the image processing apparatus 10 as information on an apparatus that performs a predetermined process on the paper stacked on the paper tray (hereinafter, referred to as “apparatus information”). Here, the “predetermined process on the paper” includes, for example, a process of transporting the paper, a process of forming an image on the paper, and the like. In addition, the apparatus information includes information related to an environment in which the image processing apparatus 10 is installed (hereinafter, referred to as “environment information”) and information related to the performance of the image processing apparatus 10 (hereinafter, referred to as “performance information”). In addition, the apparatus information includes information (hereinafter, referred to as “setting information”) related to various types of setting related to the image processing apparatus 10.

The environment information in the apparatus information includes at least one of humidity of a place where the image processing apparatus 10 is installed or moisture content of paper stacked on the paper tray of the image processing apparatus 10. The “moisture content of the paper” refers to the percentage of moisture contained in the paper. The moisture content of the paper is calculated, for example, by the weight of the moisture contained in the paper with respect to the weight of the paper. The moisture content of the paper is detected by, for example, a predetermined sensor such as an infrared moisture sensor, a microwave moisture sensor, a capacitance type sensor, or a resistance type moisture sensor. In addition, the performance information in the apparatus information includes a transport speed in a case where paper is transported.

In addition, the image processing apparatus 10 controls the flow rate of air blown to the side surface of the bundle of paper, based on the captured image acquired as the information representing the state of the floating paper and the apparatus information. Specifically, the image processing apparatus 10 detects the edge portion of the paper from the captured image and determines the behavior of the paper. The image processing apparatus 10 controls the flow rate of air blown to the side surface of the bundle of paper based on the determination result related to the behavior of the paper and the apparatus information different for each image processing apparatus 10.

The image processing apparatus 10 according to the first exemplary embodiment can control the flow rate of air blown to the side surface of the bundle of paper using a trained machine learning model (hereinafter, referred to as “the base model”) that outputs a determination result related to the behavior of the paper in a case where a captured image is input. The base model is generated for each capturing condition by performing learning using a combination of the captured image and a determination result related to the behavior of the paper as learning data for each condition related to capturing (hereinafter, referred to as an “capturing condition”) specified from the apparatus information.

The capturing condition includes, for example, a capturing condition related to a temperature at the time of capturing, a capturing condition related to humidity, a capturing condition related to a transport speed at the time of transporting paper, and the like. In addition, the capturing condition includes a capturing condition related to the brand, the type, and the size of the paper. Here, as the capturing condition related to the humidity, the adhesion of paper (tendency to be bundled) is likely to occur in the high humidity environment, so that the control of increasing the flow rate is performed rather than the low humidity environment. In addition, as the capturing condition related to the transport speed, in a case where the transport speed is high, in order to keep up with the paper feeding, control is performed to float a larger amount of paper than a case where the transport speed is low. In addition, as the capturing condition related to the type of paper, the adhesion of coated paper, which is coated with a coating agent such as a pigment on the surface and finished, is likely to occur (likely to be bundled) compared as normal paper, so that the control of increasing the flow rate is performed rather than the normal paper. In addition, as the capturing condition related to the size of the paper, the printing of small-sized paper is expected to have a qualitatively and quantitatively excellent quality, so that the control may be performed differently from the printing of large-sized paper.

That is, the number of the base models generated in the first exemplary embodiment is not limited to one and may be plural. Therefore, the image processing apparatus 10 controls the flow rate of air to be blown to the side surface of the bundle of paper using a base model corresponding to the capturing condition specified from the acquired apparatus information. The details of configuration and process of the image processing apparatus 10 will be described later.

### User Terminal 30

The user terminal 30 is an information processing apparatus such as a smartphone, a tablet terminal, or a personal computer operated by the user who uses the information processing system 1. The user terminal 30 is installed with application software that enables the generation of print data, the issuance of an instruction to execute the printing process or the like to the image processing apparatus 10 via the operation screen as the user interface.

The user terminal 30 can transmit various types of information to the image processing apparatus 10 and the outside. For example, the user terminal 30 can generate the print data based on the input operation of the user and transmit the print data to the image processing apparatus 10. For example, the user terminal 30 can transmit an instruction to execute the printing process or the like input on the operation screen to the image processing apparatus 10. In addition, the user terminal 30 can acquire various types of information transmitted from the image processing apparatus 10 and the outside, and execute various types of processes.

The above configuration of the information processing system 1 is merely an example, and the information processing system 1 as a whole may have functions that realize the above processing. Therefore, a part or all of the functions for realizing the process described above may be shared or cooperated in the information processing system 1. That is, a part or all of the functions of the image processing apparatus 10 configuring the information processing system 1 may be used as the functions of another information processing apparatus (for example, the user terminal 30). In addition, a part or all of the functions of another information processing apparatus may be used as the function of the image processing apparatus 10. Further, a part or all of the functions of the image processing apparatus 10 or other apparatuses which configure the information processing system 1 may be transferred to another server (not illustrated). Accordingly, the processing of the information processing system 1 as a whole may be accelerated, and, in addition, the processing can also be complemented.

### Hardware Configuration

### Hardware Configuration of Image Processing Apparatus 10

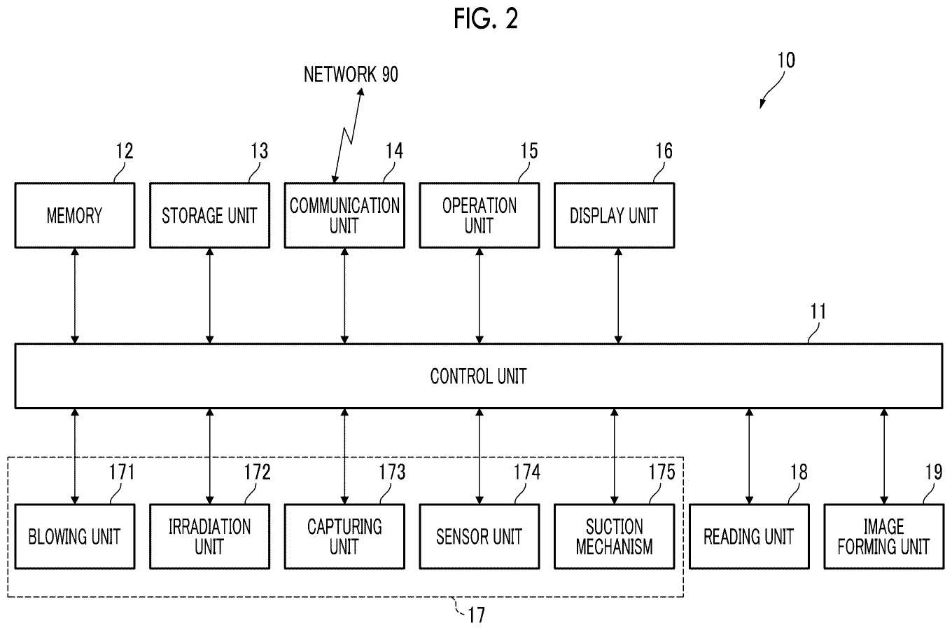

FIG. 2 is a diagram illustrating an example of a hardware configuration of the image processing apparatus 10 configuring the information processing system 1 of FIG. 1.

The image processing apparatus 10 includes a control unit 11, a memory 12, a storage unit 13, a communication unit 14, an operation unit 15, a display unit 16, a paper tray 17, a reading unit 18, and an image forming unit 19. The above units are connected to each other via a data bus, an address bus, a Peripheral Component Interconnect (PCI) bus, or the like.

The control unit 11 is a processor that controls functions of the image processing apparatus 10 based on execution of various types of software such as an OS (basic software) and application software.

In the exemplary embodiments, the processes are performed by any computer. The computer may perform the processes by using a processor serving as hardware, a program serving as software, or combination of these. In this case, the processor is configured to perform the processes in the exemplary embodiments in cooperation with the program and may function as a unit or a means in the exemplary embodiments. The order in which the processor performs the processes is not limited to the described order and may be changed appropriately. The computer may be a general-purpose computer, an application specific computer, a workstation, or another system capable of performing the processes.

The processor may be composed of one or more pieces of hardware, and the type of the hardware is not limited. For example, the processor may be composed of hardware such as a central processing unit (CPU), a micro processing unit (MPU), a programmable logic device such as a field programmable gate array (FPGA), a dedicated circuit for performing specific processing such as an application specific integrated circuit (ASIC), a graphics processing unit (GPU), or a neural processing unit (NPU).

Regarding the type of the hardware, different types of hardware may be combined. If multiple pieces of hardware are configured to perform one or more processes of the processor, the multiple pieces of hardware may be present in apparatuses physically away from each other or may be present in one apparatus. In each of exemplary embodiments, the order in which the processor performs the processes is not limited to the order described above and may be changed appropriately. The hardware is composed of electric circuitry in which circuit elements such as semiconductor devices are combined, or the like.

Further, the program may be software such as firmware or microcode. The program may be, for example, a program module group, and the functions thereof may be implemented by processors configured to implement the respective functions. The program may be program code or multiple code segments stored in one or more non-transitory computer readable media (for example, a storage medium or another storage). The program may be stored in such a divided manner in multiple non-transitory computer readable media present in apparatuses physically away from each other.

The program code or the code segments may represent a procedure, a function, a sub program, a routine, a subroutine, a module, a software package, a class or any combination of instructions, data structures, or program statements. The program code or the code segment may be connected to another code segment or a hardware circuit by transmitting and/or receiving information, data, an argument, a parameter, or memory content.

The memory 12 is a storage region in which various types of software, pieces of data used for executing the software, or the like are stored, and is used as a work area in calculations. The memory 12 is configured of, for example, a random access memory (RAM).

The storage unit 13 is a storage region in which input data for various types of software, output data from various types of software, or the like are stored. The storage unit 13 is configured of, for example, a hard disk drive (HDD), a solid state drive (SSD), or a semiconductor memory, which is used for storing programs, various types of setting data, or the like. The storage unit 13 is provided with a database that stores various types of information.

The communication unit 14 transmits and receives data to and from the user terminal 30 and an outside via the network 90. The operation unit 15 is configured of, for example, a keyboard, a mouse, a mechanical button, or a switch, and receives an input operation.

The operation unit 15 also includes a touch sensor integrally configuring a touch panel with the display unit 16.

The display unit 16 is configured of, for example, a liquid crystal display or an organic electro luminescence (EL) display to be used for information display, and displays data of an image or a text and the like. The display unit 16 displays a user interface or the like.

The paper tray 17 is a mechanism that can stack and store paper to be used for printing, is disposed inside the image processing apparatus 10, or is disposed outside the image processing apparatus 10. The paper tray 17 corresponds to, for example, various paper sizes such as A4, A3, and letter size. The paper tray 17 includes a paper feeding tray (also referred to as an “input tray”), a paper discharge tray (also referred to as an “output tray”), a manual feed tray, and the like.

The paper feeding tray is a tray on which blank paper can be stacked before printing. In many cases, paper having different sizes and types are simultaneously stacked on each of the plurality of paper feeding trays. The paper discharge tray is a tray from which paper on which the printing is completed is discharged. The manual feed tray is an auxiliary tray used in a case of printing a small amount of special paper (for example, thick paper or an envelope). The paper tray 17 in the present exemplary embodiment is a paper feeding tray, and is configured to enable continuous printing by stacking several hundreds of sheets of paper.

The paper tray 17 includes a blowing unit 171 that blows air toward a side surface of a bundle of stacked paper, an irradiation unit 172 that irradiates the side surface of the bundle of stacked paper with illumination light as an irradiation section, and a capturing unit 173 that captures the side surface of the bundle of stacked paper as a capturing section. In addition, the paper tray 17 includes a sensor unit 174 consisting of various sensors capable of detecting the environment information of the image processing apparatus 10, and a suction mechanism 175 that sucks the paper to be transported.

The blowing unit 171 blows air toward the side surface of the bundle of paper that are stacked to separate and float the paper one by one. Accordingly, the occurrence of a double-feeding error in which a plurality of sheets of paper are fed in a state in which the paper are stuck together is suppressed. The blowing unit 171 is particularly effective in a case where a large amount of printing is performed or in an environment in which the paper is likely to stick due to humidity. The blowing unit 171 is configured of, for example, a fan or an air duct disposed in the paper tray 17.

The irradiation unit 172 is configured of a light source such as a light emitting diode (LED), and irradiates the side surface of the bundle of the stacked paper with illumination light. As a result, the capturing by the capturing unit 173 which will be described later is assisted.

The capturing unit 173 is configured of a camera, an image sensor, an optical unit, or the like, and captures a side surface of a bundle of stacked paper. The camera is configured of, for example, a multi-wavelength spectroscopic camera. The multi-wavelength spectroscopic camera includes, for example, a hyperspectral camera, a multispectral camera, and a camera in which a color filter portion of an RGB camera is changed for a predetermined wavelength. In addition, the camera may be an infrared camera having a single wavelength.

The sensor unit 174 is configured of various sensors such as a temperature sensor, a humidity sensor, an infrared moisture sensor, a microwave moisture sensor, a capacitance type sensor, and a resistance type moisture sensor. The sensor unit 174 detects a temperature, a humidity, a moisture content of paper stacked in the paper tray 17, and the like as the environment information of the image processing apparatus 10.

The suction mechanism 175 is a mechanism that sucks the paper for accurate transport by sucking the floating paper one by one.

The reading unit 18 reads an image recorded on a medium such as paper. The reading unit 18 may be configured of, for example, a CCD (Charge Coupled Devices) type scanner that reduces reflected light with respect to light emitted from a light source to an original document with a lens and receives the reflected light with a CCD. In addition, the reading unit 18 may be configured of a contact image sensor (CIS) type scanner or the like that receives reflected light with respect to light emitted in order from an LED light source to an original document.

The image forming unit 19 forms an image to be printed on a printing surface of paper as a recording medium by, for example, an electrophotographic method, an inkjet method, or the like.

### Hardware Configuration of User Terminal 30

The user terminal 30 includes a control unit, a memory, a storage unit, a communication unit, an operation unit, and a display unit respectively corresponding to the control unit 11, the memory 12, the storage unit 13, the communication unit 14, the operation unit 15, and the display unit 16 illustrated in FIG. 2. These units are connected to each other via a data bus, an address bus, a PCI bus, or the like.

### Functional Configuration of Image Processing Apparatus 10

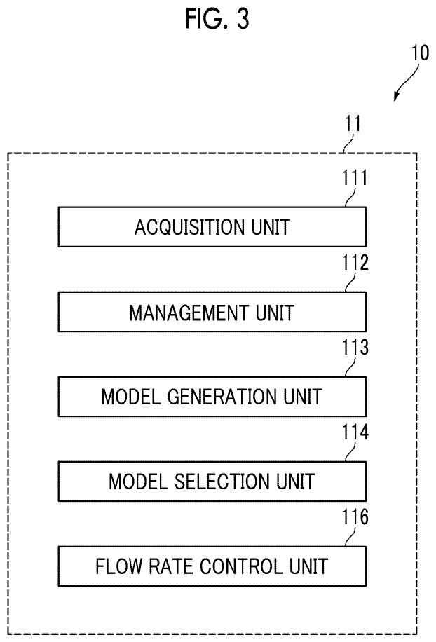

FIG. 3 is a diagram illustrating an example of a functional configuration of the control unit 11 of the image processing apparatus 10.

In the control unit 11 of the image processing apparatus 10, an acquisition unit 111, a management unit 112, a model generation unit 113, a model selection unit 114, and a flow rate control unit 116 function.

The acquisition unit 111 acquires various types of information. For example, the acquisition unit 111 acquires the input information input to the operation screen displayed on the display unit 16 (see FIG. 2). In addition, the acquisition unit 111 acquires the input information input to the operation screen displayed on the user terminal 30. In addition, the acquisition unit 111 acquires the captured image captured by the capturing unit 173 (see FIG. 2) of the paper tray 17.

In addition, the acquisition unit 111 acquires the apparatus information of the image processing apparatus 10. For example, the acquisition unit 111 acquires, as the apparatus information, the environment information detected by the sensor unit 174 (see FIG. 2) of the paper tray 17. In addition, the acquisition unit 111 acquires the performance information of the image processing apparatus 10 as the apparatus information. The performance information may be managed by the management unit 112 which will be described later, or may be acquired from the outside via the network 90. In this case, the “outside” may be, for example, a web page on which various types of information provided from the manufacturer of the image processing apparatus 10 are posted. In addition, the acquisition unit 111 acquires, as the apparatus information, setting information on a flow rate with which the blowing unit 171 (see FIG. 2) of the paper tray 17 blows air toward the bundle of paper.

The management unit 112 stores and manages various types of information in the database of the storage unit 13 (see FIG. 2). For example, the management unit 112 stores and manages the captured image as the information representing the state of the floating paper, which is acquired by the acquisition unit 111, in the database. In addition, the management unit 112 stores and manages the apparatus information acquired by the acquisition unit 111 in the database. In addition, the management unit 112 stores and manages the control result of the flow rate by the flow rate control unit 116 which will be described later in the database. The control result of the flow rate by the flow rate control unit 116 includes a determination result related to the behavior of the paper.

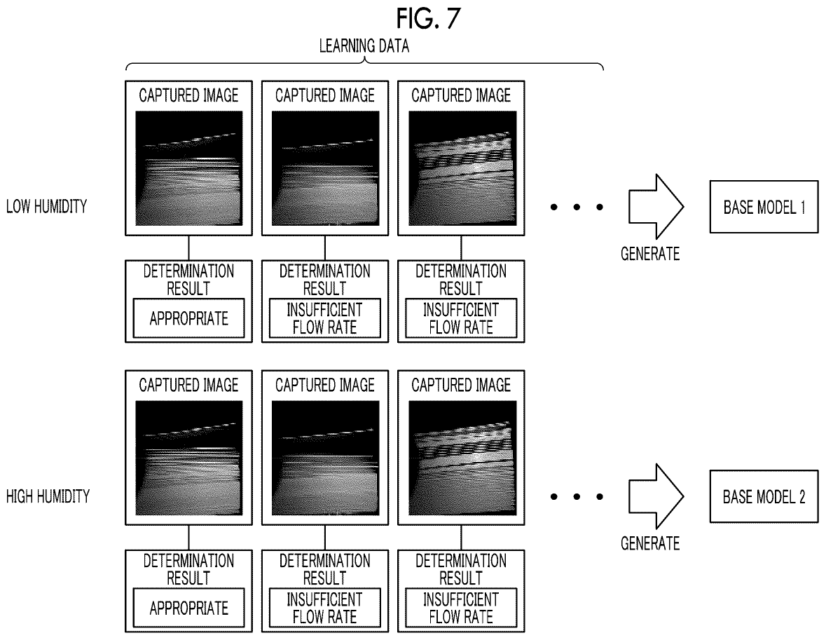

The model generation unit 113 generates the base model. Specifically, the model generation unit 113 generates the base model for each capturing condition by performing learning using a combination of the captured image captured by the capturing unit 173 and the determination result related to the behavior of the paper as learning data for each capturing condition. Therefore, a plurality of base models are generated by the model generation unit 113. The model generation unit 113 repeats the above-described learning with respect to the base model in order to improve the accuracy of the determination result output from the generated base model. A specific example of the base model generated by the model generation unit 113 will be described later with reference to FIG. 7.

The model selection unit 114 selects a base model to be used for the control of the flow rate from among the plurality of base models. Specifically, the model selection unit 114 selects a base model corresponding to the capturing condition specified from the apparatus information, from among the base models generated for each capturing condition.

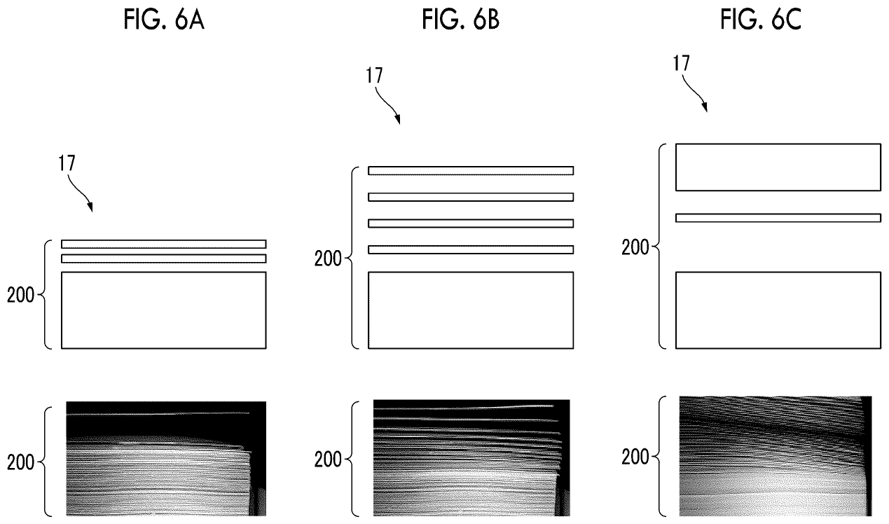

The flow rate control unit 116 controls the flow rate of air blown toward the bundle of paper by the blowing unit 171, based on the captured image and the apparatus information acquired by the acquisition unit 111. Specifically, the flow rate control unit 116 detects an edge portion of the paper from the captured image acquired by the acquisition unit 111 to determine the behavior of the paper, and controls the flow rate based on the determination result and the apparatus information. A way that the flow rate control unit 116 determines the behavior of the paper will be described later with reference to FIGS. 6A to 6C.

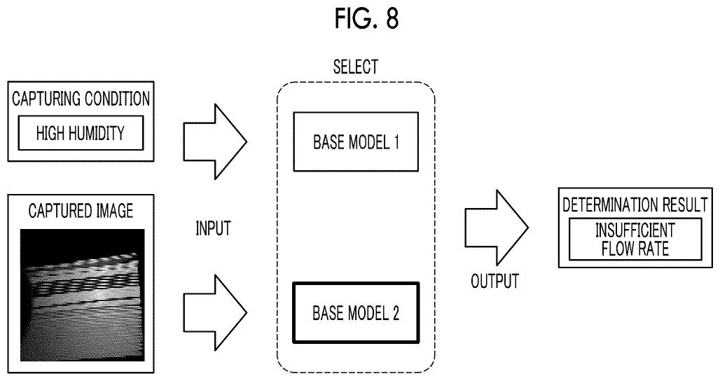

In addition, the flow rate control unit 116 can control the flow rate using the base model. In this case, the flow rate control unit 116 controls the flow rate using the base model generated for each capturing condition by the model generation unit 113 and selected by the model selection unit 114. Specifically, the flow rate control unit 116 controls the flow rate based on the determination result related to the behavior of the paper output by inputting the captured image captured by the capturing unit 173 to the base model and the environment information, the performance information, the setting information, and the like as the apparatus information. A specific example of a case where the flow rate is controlled using the base model will be described later with reference to FIG. 8.

In addition, the flow rate control unit 116 may control the flow rate in accordance with an input operation of the user who has checked the determination result related to the behavior of the paper.

### Flow of Process of Image Processing Apparatus 10

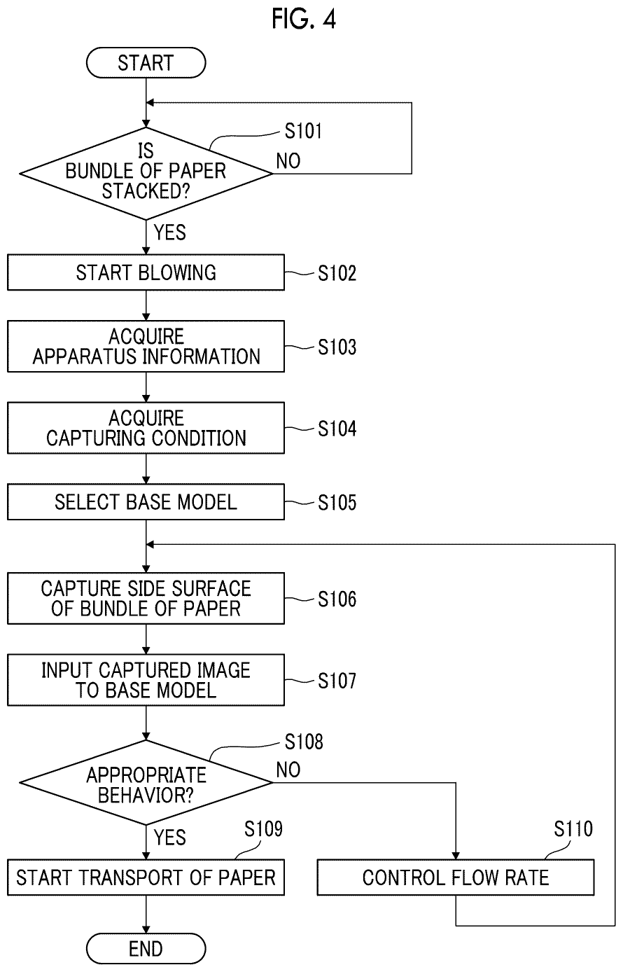

FIG. 4 is a flowchart illustrating an example of a flow of a process until the transport of the paper starts among the processes of the image processing apparatus 10.

In a case where a bundle of paper is stacked on the paper tray (YES in step S101), the image processing apparatus 10 starts blowing air (step S102). Specifically, the image processing apparatus 10 starts a process of blowing air toward the side surface of the bundle of paper stacked on the blowing unit 171 (see FIG. 2) of the paper tray 17. On the other hand, in a case where the bundle of paper is not stacked on the paper tray (NO in step S101), the image processing apparatus 10 repeats the determination process in step S101.

The image processing apparatus 10 acquires the apparatus information (step S103). The acquired apparatus information includes, in addition to the setting information on the flow rate in which air is blown by the blowing unit 171 toward the bundle of paper, the environment information, the performance information, and the like. In addition, the image processing apparatus 10 acquires the capturing condition (step S104).

The image processing apparatus 10 selects the base model used for the control of the flow rate (step S105). Specifically, the image processing apparatus 10 selects the base model corresponding to the capturing condition specified from the apparatus information from among the base models generated for each capturing condition.

The image processing apparatus 10 captures the side surface of the bundle of paper stacked on the paper tray 17 (step S106). Specifically, the image processing apparatus 10 causes the irradiation unit 172 (see FIG. 2) to irradiate the bundle of paper with light, and causes the capturing unit 173 (see FIG. 2) to capture a state in which the paper floats from the bundle of paper.

The image processing apparatus 10 inputs the captured image captured in step S106 to the base model (step S107). In a case where the determination result related to the behavior of the paper output from the base model is determined to be the appropriate behavior (YES in step S108), the image processing apparatus 10 starts to transport the paper stacked on the paper tray 17 (step S109). Accordingly, the process until the transport of the paper starts ends (END). On the other hand, in a case where the determination result related to the behavior of the paper output from the base model is determined to be the inappropriate behavior (NO in step S108), the image processing apparatus 10 controls the flow rate (step S110) and returns to the process of step S106. That is, the image processing apparatus 10 captures the side surface of the bundle of paper stacked on the paper tray 17 again.

### Specific Example

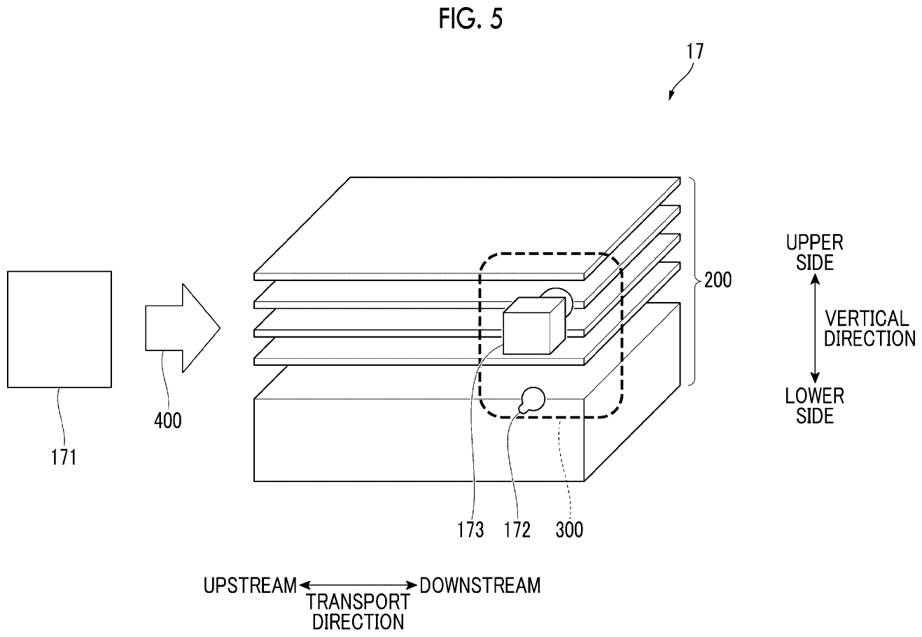

FIG. 5 is a diagram illustrating a specific example of the paper tray 17 in FIG. 2.

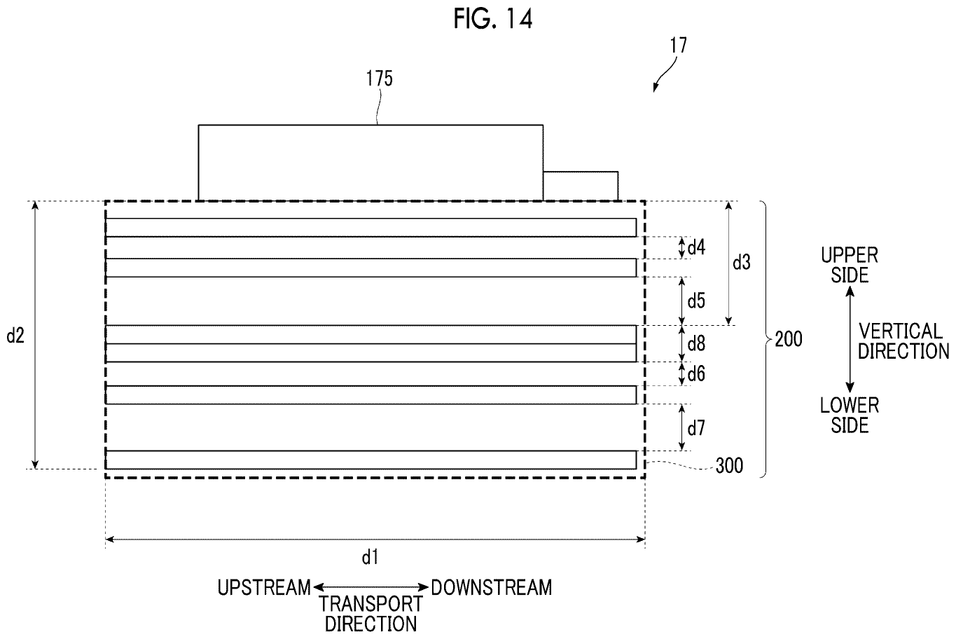

As illustrated in FIG. 5, the blowing unit 171 that blows air 400 toward the side surface of the bundle of the stacked paper 200 to float the paper 200 one by one is disposed in the paper tray 17. In addition, the irradiation unit 172 that irradiates the side surface of the bundle of paper 200 with illumination light and the capturing unit 173 that captures a capturing area 300 which is a part of the side surface of the bundle of paper 200 are disposed in the paper tray 17. In addition, although not illustrated in FIG. 5, a suction mechanism 175 (see FIG. 14) for sucking and transporting the paper one by one is disposed in the paper tray 17.

Hereinafter, a direction in which the paper 200 is transported is referred to as a “transport direction”. The paper 200 stacked on the paper tray 17 is transported toward the downstream side in the transport direction. In addition, a direction in which the paper 200 is floated by blowing air 400 toward the bundle of the paper 200 is referred to as a “vertical direction”. The paper 200 to which the air 400 is blown floats upper side in the vertical direction.

FIGS. 6A to 6C are diagrams illustrating a state in a case where air is blown to a bundle of paper 200 stacked on the paper tray 17.

FIG. 6A shows a schematic diagram (upper stage) and a captured image (lower stage) showing a state in a case where the flow rate of air blown to the bundle of paper 200 is insufficient. As illustrated in FIG. 6A, in a case where the flow rate of air blown to the bundle of paper 200 is insufficient, for example, the desired amount (number of paper) of the paper 200 is not floated. In this case, the determination result related to the behavior of the paper output from the base model to which the captured image is input is determined to be the inappropriate behavior. Therefore, the image processing apparatus 10 (see FIG. 1) performs a control of increasing the flow rate of air blown to the bundle of paper 200.

FIG. 6B shows a schematic diagram (upper stage) and a captured image (lower stage) showing a state in a case where the flow rate of air blown to the bundle of paper 200 is appropriate. As illustrated in FIG. 6B, for example, in a case where the flow rate of the air blown to the bundle of paper 200 is desirable, for example, the paper 200 in a desired amount are floated, and the floated paper 200 are separated one by one. In this case, the determination result related to the behavior of the paper output from the base model to which the captured image is input is determined to be the appropriate behavior. Therefore, the image processing apparatus 10 performs a control to hold the flow rate of air blown to the bundle of paper 200.

FIG. 6C illustrates a schematic diagram (upper stage) and a captured image (lower stage) showing a state in a case where the air blown to the bundle of paper 200 indicates an excessive flow rate. As illustrated in FIG. 6C, in a case where the flow rate of air blown to the bundle of paper 200 indicates an excessive flow rate, for example, the paper 200 in a desired amount are floated, but the floated paper 200 are not separated one by one, and a bias occurs. In this case, the determination result related to the behavior of the paper output from the base model to which the captured image is input is determined to be the inappropriate behavior. Therefore, the image processing apparatus 10 performs control to reduce the flow rate of air blown to the bundle of paper 200.

FIG. 7 is a diagram illustrating a specific example of the base model generated for each capturing condition.

As described above, the model generation unit 113 (see FIG. 3) generates the base model for each capturing condition by performing learning using a combination of the captured image captured by the capturing unit 173 (see FIG. 2) and the determination result related to the behavior of the paper as learning data for each capturing condition. FIG. 7 shows a base model 1 and a base model 2 generated for each capturing condition related to the humidity at the time of capturing, as a specific example.

In the upper stage of FIG. 7, as a specific example of the learning data used for the learning in which the capturing condition is “low humidity”, a plurality of combinations of the captured image and the determination result are illustrated. The base model 1 is generated by performing learning using the learning data illustrated in the upper stage of FIG. 7. In addition, in the lower stage of FIG. 7, as a specific example of the learning data used for the learning in which the capturing condition is set to “high humidity”, a plurality of combinations of the captured image and the determination result are illustrated. The base model 2 different from the base model 1 is generated by performing learning using the learning data illustrated in the lower stage of FIG. 7.

FIG. 8 is a diagram illustrating a specific example in a case where the flow rate is controlled using the base model.

As described above, the image processing apparatus 10 (see FIG. 1) selects the base model corresponding to the acquired capturing condition from among the plurality of base models generated and managed for each capturing condition. For example, as illustrated in FIG. 8, in a case where the capturing condition is “high humidity”, the image processing apparatus 10 selects the base model generated by performing the learning of setting the capturing condition to “high humidity”.

Here, as in the example of FIG. 7 described above, it is assumed that the image processing apparatus 10 manages the base model 1 generated by causing the learning in which the capturing condition is set to “low humidity” and the base model 2 generated by causing the learning in which the capturing condition is set to “high humidity”. In this case, the image processing apparatus 10 selects the base model 2, inputs the captured image to the base model 2, and outputs the determination result related to the behavior of the paper. In the example of FIG. 8, “insufficient flow rate” is output as the determination result related to the behavior of the paper.

### Second Exemplary Embodiment

The first exemplary embodiment described above is configured in which the learning is performed for each capturing condition using a combination of the captured image and the determination result related to the behavior of the paper as learning data, the base model is generated for each capturing condition. That is, the number of generated base models is plural. Therefore, the image processing apparatus 10 selects the base model corresponding to the capturing condition from among the plurality of base models, and controls the flow rate based on the determination result related to the behavior of the paper output from the selected base model.

On the other hand, a second exemplary embodiment is a configuration in which the learning is performed using a combination of the captured image, the determination result related to the behavior of the paper, and the capturing condition as learning data. Therefore, the number of generated base models is one. The image processing apparatus 10 controls the flow rate based on a determination result related to the behavior of the paper output from one generated base model.

### Specific Example

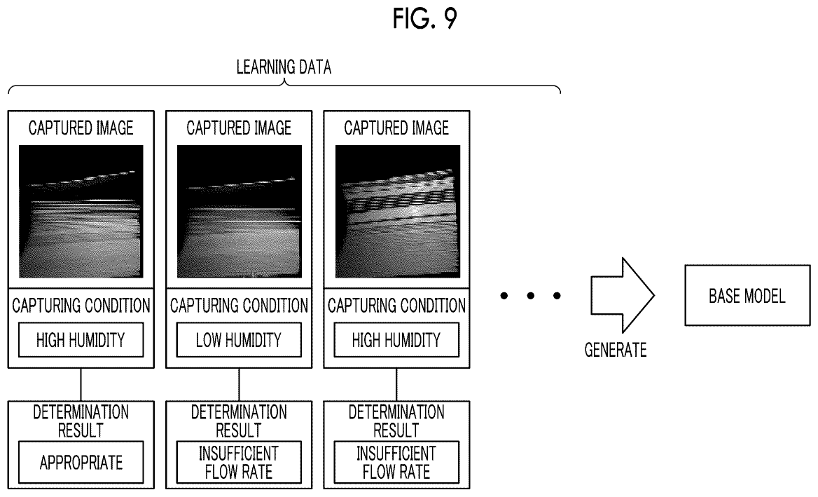

FIG. 9 is a diagram illustrating a specific example of the base model generated by the image processing apparatus 10 according to the second exemplary embodiment. The hardware configuration of the image processing apparatus 10 according to the second exemplary embodiment is the same as the configuration illustrated in FIG. 2 described above. In addition, the functional configuration of the control unit 11 of the image processing apparatus 10 according to the second exemplary embodiment is basically the same as the configuration illustrated in FIG. 3 described above, but is different in that the model selection unit 114 in FIG. 3 is not provided.

FIG. 9 illustrates the base model generated for each capturing condition related to the humidity when capturing is performed. In addition, FIG. 9 illustrates a plurality of combinations of the captured images, the determination results, and the capturing condition as a specific example of the learning data used for the learning. Specifically, as the learning data, a combination of the captured image, the capturing condition (high humidity), and the determination result (appropriate) related to the behavior of the paper, a combination of the captured image, the capturing condition (low humidity) and the determination result (insufficient flow rate) related to the behavior of the paper, and the like are illustrated. By performing learning using the learning data, one base model is generated.

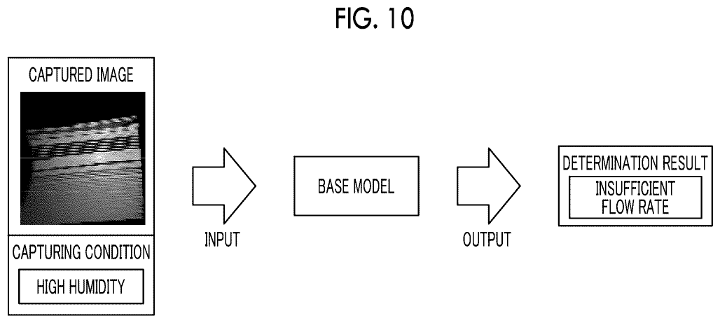

FIG. 10 is a diagram illustrating a specific example in a case where the flow rate is controlled using one base model generated by the image processing apparatus 10 according to the second exemplary embodiment.

As in the example of FIG. 9 described above, in a case where one base model is generated by performing learning using a combination of the captured image, the capturing condition, and the determination result related to the behavior of the paper as learning data, the image processing apparatus 10 (see FIG. 1) performs the following process. That is, the image processing apparatus 10 inputs the captured image to the generated one base model and outputs a determination result related to the behavior of the paper. In the example of FIG. 10, “insufficient flow rate” is output as the determination result related to the behavior of the paper.

### Flow of Process of Image Processing Apparatus 10

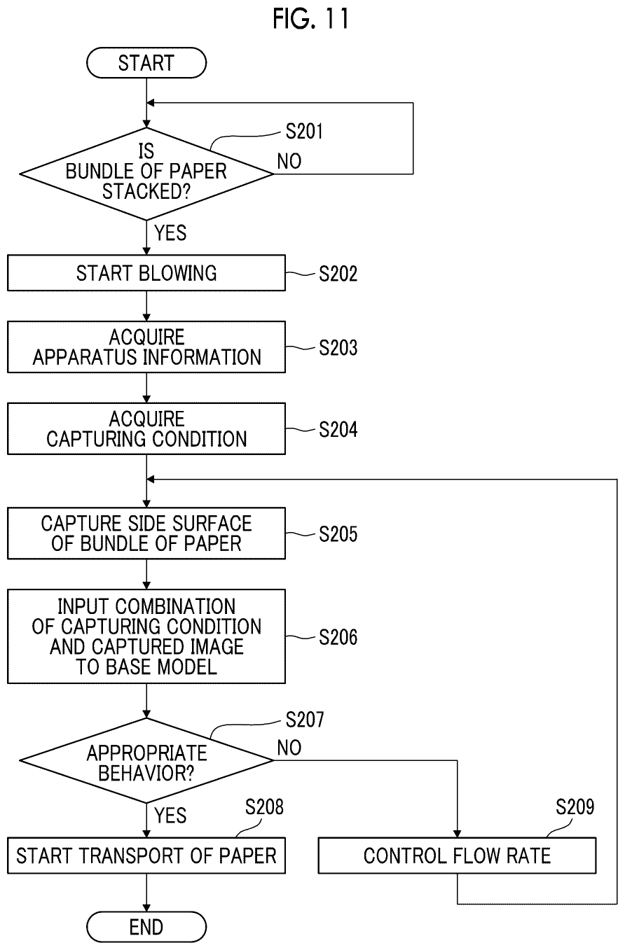

FIG. 11 is a flowchart illustrating an example of a flow of the process until the transport of the paper starts in the process of the image processing apparatus 10 according to the second exemplary embodiment. The processes of steps S201 to S204 in the process illustrated in FIG. 11 are the same as the processes of steps S101 to S104 in the flowchart illustrated in FIG. 4 described above, and thus the description thereof will be omitted.

In step S204, the image processing apparatus 10 that has acquired the capturing condition captures the side surface of the bundle of paper stacked on the paper tray 17 (step S205). Next, the image processing apparatus 10 inputs a combination of the capturing condition acquired in step S204 and the captured image captured in step S205 to the base model (step S206). In a case where the determination result related to the behavior of the paper output from the base model is determined to be the appropriate behavior (YES in step S207), the image processing apparatus 10 starts the transport of the paper stacked on the paper tray 17 (step S208). Accordingly, the process until the transport of the paper starts ends (END). On the other hand, in a case where the determination result related to the behavior of the paper output from the base model is determined to be the inappropriate behavior (NO in step S207), the image processing apparatus 10 controls the flow rate (step S209) and returns to the process of step S205. That is, the image processing apparatus 10 captures the side surface of the bundle of paper stacked on the paper tray 17 again.

### Third Exemplary Embodiment

The first and second exemplary embodiments described above are configurations that enable the flow rate to be controlled based on the determination result related to the behavior of the paper output from the base model. On the other hand, a third exemplary embodiment is a configuration in which the flow rate is controlled based on the determination result related to the behavior of the paper obtained by digitizing the position of the paper and the like, instead of using the base model. Here, the “position of the paper and the like” refers to the number of floating paper, the position, the interval, the thickness of the bundle (the number of paper of paper), and the like of each of the floating paper.

### Functional Configuration of Image Processing Apparatus 10

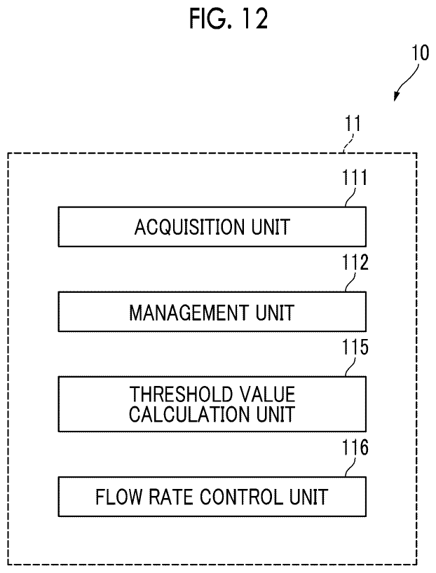

FIG. 12 is a diagram illustrating an example of a functional configuration of the control unit 11 of the image processing apparatus 10 according to the third exemplary embodiment. The hardware configuration of the image processing apparatus 10 according to the third exemplary embodiment is the same as the hardware configuration illustrated in FIG. 2 described above.

In the control unit 11 of the image processing apparatus 10 according to the third exemplary embodiment, an acquisition unit 111, a management unit 112, a threshold value calculation unit 115, and a flow rate control unit 116 function.

The acquisition unit 111 has the same configuration as the first exemplary embodiment illustrated in FIG. 3, and the description thereof will be omitted.

In addition to the configuration of the first exemplary embodiment illustrated in FIG. 3 described above, the management unit 112 stores and manages a threshold value (hereinafter, simply referred to as a “threshold value”), which is determined for each capturing condition and is the reference when the behavior of the paper is determined, in a database in advance. In addition, the management unit 112 stores and manages the threshold value calculated for each capturing condition by a threshold value calculation unit 115 which will be described later in a database.

The management unit 112 manages a predetermined threshold value. The “predetermined threshold value” includes, for example, the following information. That is, information in which “excessive flow rate” is determined in a case in which the number of floating paper is equal to or greater than 5 as the threshold value when the capturing condition is “low humidity” and there is a bundle in 5 sheets of paper from an upper side in the vertical direction. In this case, information in which it is determined to be the “insufficient flow rate” in a case where the number of floating paper is less than 5. Information in which “excessive flow rate” is determined in a case in which the number of floating paper is equal to or greater than 10 as the threshold value when the capturing condition is “high humidity” and there is a bundle in 10 sheets of paper from the upper side in the vertical direction. In this case, information determined to be “the insufficient flow rate” when the number of floating paper is less than 10. The above information is managed as the threshold value.

The threshold value calculation unit 115 can calculate a threshold value for each capturing condition. Specifically, the threshold value calculation unit 115 calculates the threshold value by the interpolation calculation, for example, in a case where the capturing condition is acquired as a continuous value such as a humidity of 0%. For example, it is assumed that it is predetermined that, in a case where the number of floating paper is less than 5 when the capturing condition is a humidity of 50% (low humidity), it is determined to be the “insufficient flow rate”. In addition, it is assumed that it is predetermined that, in a case where the number of floating paper is less than 10 when the capturing condition is a humidity of 100% (high humidity), it is determined to be the “insufficient flow rate”.

In this case, the threshold value calculation unit 115 calculates the threshold value by the interpolation calculation. For example, in a case where the humidity specified from the environment information acquired as the apparatus information at the time of capturing is 80%, the following interpolation calculation is performed. That is, the threshold value calculation unit 115 performs, as an interpolation calculation, calculation determined to be “insufficient flow rate” in a case where the number of floating paper is less than eight when the capturing condition is a humidity of 80% (high humidity), and dynamically sets a calculation result as the threshold value.

The flow rate control unit 116 controls the flow rate using the predetermined threshold value for each capturing condition in addition to the configuration of the first exemplary embodiment illustrated in FIG. 3 described above. Specifically, the flow rate control unit 116 digitizes the position of the paper and the like obtained from the analysis result of the captured image acquired by the acquisition unit 111, and determines the behavior of the paper by comparing the digitized position and the like with the predetermined threshold value for each capturing condition. The flow rate control unit 116 controls the flow rate based on the determination result related to the behavior of the paper. A specific example of the position of the paper and the like obtained from the analysis result of the captured image will be described later with reference to FIG. 14.

### Flow of Process of Image Processing Apparatus 10

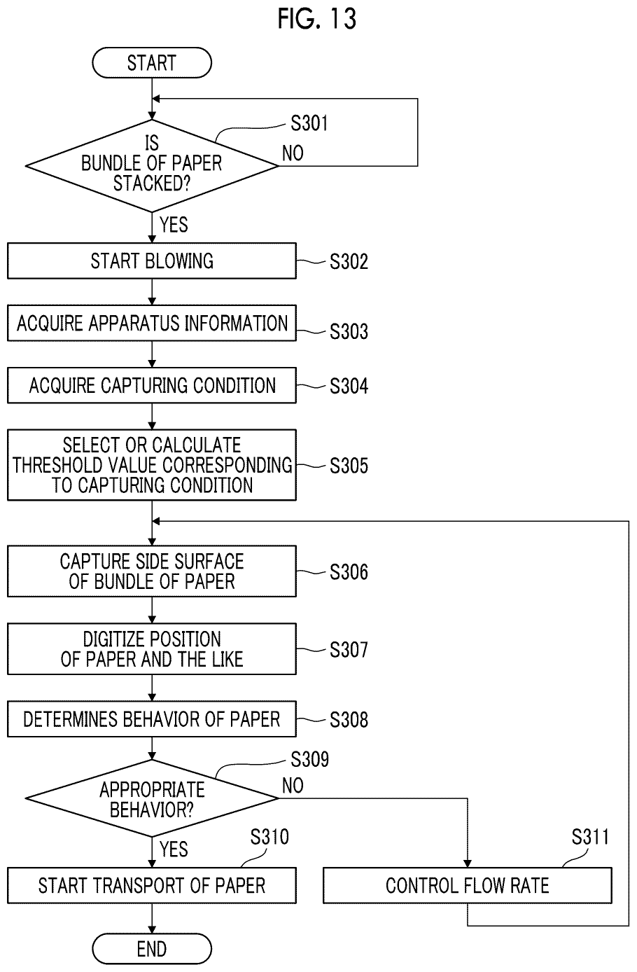

FIG. 13 is a flowchart illustrating an example of a flow of process until the transport of the paper starts in the process of the image processing apparatus 10 according to the third exemplary embodiment. The processes of steps S301 to S304 in the process illustrated in FIG. 13 are the same as the processes of steps S101 to S104 in the flowchart illustrated in FIG. 4 described above, and thus the description thereof will be omitted.

In step S304, the image processing apparatus 10 that acquired the capturing condition selects or calculates a threshold value corresponding to the acquired capturing condition (step S305), and captures a side surface of a bundle of paper stacked on the paper tray 17 (step S306). Next, the image processing apparatus 10 digitizes the position of the paper and the like obtained from the analysis result of the captured image (step S307), and determines the behavior of the paper by comparing the digitized position with a predetermined threshold value for each capturing condition (step S308).

In a case where the determination result in step S308 is determined to be the appropriate behavior (YES in step S309), the image processing apparatus 10 starts to transport the paper stacked on the paper tray 17 (step S310). Accordingly, the process until the transport of the paper starts ends (END). On the other hand, in a case where the determination result related to the behavior of the paper output from the base model is determined to be the inappropriate behavior (NO in step S309), the image processing apparatus 10 controls the flow rate (step S311) and returns to the process of step S306. That is, the image processing apparatus 10 captures the side surface of the bundle of paper stacked on the paper tray 17 again.

### Specific Example

FIG. 14 is a diagram illustrating a specific example of the position of the paper and the like obtained from the analysis result of the captured image.

As described above, the image processing apparatus 10 (see FIG. 1) according to the third exemplary embodiment digitizes the position of the paper and the like obtained from the analysis result of the captured image captured by the capturing unit 173 (see FIG. 2), and determines the behavior of the paper by comparing the digitized position with the predetermined threshold value for each capturing condition. The digitized position of the paper and the like include, for example, the number of floating paper, the interval, the thickness of the bundle (the number of paper), the length of the capturing area 300 in the transport direction, the length of the capturing area 300 in the vertical direction, and the like. In addition, whether or not there is a bundle among m sheets of paper (m is an integer which is equal to or greater than 2) from the upper side in the vertical direction among floating paper may be included in the digitized position of the paper.

In the example of FIG. 14, the number of floating paper is 5, the interval between the floating paper is the distance d4 to d7, and the thickness of the floating bundle (the number of paper) is the distance d8 (two sheets). In addition, the length of the capturing area 300 in the transport direction is a distance d1, and the length of the capturing area 300 in the vertical direction is a distance d2. In addition, for example, for whether or not there is a bundle among the five sheets from the upper side in the vertical direction among five sheets of floating paper, a fact that there is a bundle of two sheets of paper indicated by distance d8 is calculated. Further, the position of the bundle of paper present in an area indicated by the distance d3 from the suction mechanism 175 is also included in the digitized position of the paper and the like. In the example of FIG. 14, it is calculated that the bundle of paper is not present in the region indicated by the distance d3.

### Other Exemplary Embodiments

While the present exemplary embodiments have been described above, the present invention is not limited to the exemplary embodiments. In addition, effects of the present invention are not limited to the effects disclosed in the exemplary embodiments. For example, both the overall configuration of the information processing system 1 illustrated in FIG. 1 and the hardware configuration of the image processing apparatus 10 illustrated in FIG. 2 are merely examples for achieving the purpose of the present invention, and are not particularly limited.

In addition, the functional configuration of the image processing apparatus 10 illustrated in each of FIGS. 3 and 12 is merely an example, and is not particularly limited. As long as the information processing system 1 in FIG. 1 is provided with a function with which the above processing can be executed as a whole, a functional configuration to be used to implement the function is not limited to the example in FIGS. 3 and 12. In addition, the order of the steps of the processes of the image processing apparatus 10 illustrated in each of the flowcharts of FIGS. 4, 11, and 13 is merely an example and is not particularly limited. Not only the processing is performed in time series along the illustrated order of the steps, but also the processing may not be performed in time series and may be parallelly or individually performed. In addition, the specific examples illustrated in FIGS. 5 to 10 and 14 are merely examples and are not particularly limited.

In addition, in the third exemplary embodiment described above, the predetermined threshold value, the threshold value dynamically set by the threshold value calculation unit 115 in FIG. 12, and the determination result related to the behavior of the paper may be learned. In this case, the accuracy of the determination result related to the behavior of the paper is improved.

In addition, in the above-described exemplary embodiment, the paper tray is described as the paper feeding tray, but the present invention is not limited thereto, and may be, for example, a paper discharge tray.

The present invention can also be applied to a program and a program product.

### Supplementary Note

(((1)))

An information processing system comprising:

a processor configured to:
acquire information representing a state of floating paper in a case where air is blown to a side surface of a bundle of the paper and apparatus information related to an apparatus that performs a predetermined process on the paper; and
control a flow rate of the air based on the information representing the state and the apparatus information.
   (((2)))

The information processing system according to (((1))),

wherein the apparatus information includes at least one of environment information related to an environment in which the apparatus is installed or performance information related to a performance of the apparatus.

(((3)))

The information processing system according to (((2))),

wherein in a case where the apparatus is an image forming apparatus, the apparatus information includes at least one of humidity as the environment information or a moisture content of the paper.

(((4)))

The information processing system according to (((3))),

wherein the moisture content of the paper is detected by a predetermined sensor.

(((5)))

The information processing system according to any one of (((2))) to (((4))),

wherein, in a case where the apparatus is an image forming apparatus, the apparatus information includes a transport speed as the performance information.

(((6)))

The information processing system according to any one of (((1))) to (((5))), wherein the processor is configured to:

control the flow rate of the air using a machine learning model that outputs a determination result related to a behavior of the paper in a case where a captured image of the side surface of the bundle of paper as the information representing the state is input.

(((7)))

The information processing system according to (((6))),

wherein the machine learning model is generated for each capturing condition specified from the apparatus information by performing learning using a combination of the captured image and the determination result as learning data for each capturing condition.

(((8)))

The information processing system according to (((7))), wherein the processor is configured to:

control the flow rate of the air using the machine learning model corresponding to the capturing condition specified from the acquired apparatus information.

(((9)))

The information processing system according to (((6))),

wherein the machine learning model is generated by performing learning using a combination of the captured image, a capturing condition specified from the apparatus information, and the determination result as learning data.

(((10)))

The information processing system according to any one of (((1))) to (((9))), wherein the processor is configured to:

control the flow rate of the air using a predetermined threshold value for each capturing condition specified from the apparatus information.

(((11)))

The information processing system according to (((10))), wherein the processor is configured to:

calculate the threshold value by an interpolation calculation using a plurality of the threshold values.

(((12)))

A program executed by a computer that controls an image forming apparatus, the program causing the computer to realize:

a function of acquiring information representing a state of floating paper in a case where air is blown to a side surface of a bundle of the paper and apparatus information related to an apparatus that performs a predetermined process on the paper; and

a function of controlling a flow rate of the air based on the information representing the state and the apparatus information.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing system comprising:
a processor configured to:
acquire information representing a state of floating paper in a case where air is blown to a side surface of a bundle of the paper and apparatus information related to an apparatus that performs a predetermined process on the paper; and
control a flow rate of the air based on the information representing the state and the apparatus information.

2. The information processing system according to claim 1,
wherein the apparatus information includes at least one of environment information related to an environment in which the apparatus is installed or performance information related to a performance of the apparatus.

3. The information processing system according to claim 2,
wherein in a case where the apparatus is an image forming apparatus, the apparatus information includes at least one of humidity as the environment information or a moisture content of the paper.

4. The information processing system according to claim 3,
wherein the moisture content of the paper is detected by a predetermined sensor.

5. The information processing system according to claim 2,
wherein, in a case where the apparatus is an image forming apparatus, the apparatus information includes a transport speed as the performance information.

6. The information processing system according to claim 1, wherein the processor is configured to:
control the flow rate of the air using a machine learning model that outputs a determination result related to a behavior of the paper in a case where a captured image of the side surface of the bundle of paper as the information representing the state is input.

7. The information processing system according to claim 6,
wherein the machine learning model is generated for each capturing condition specified from the apparatus information by performing learning using a combination of the captured image and the determination result as learning data for each capturing condition.

8. The information processing system according to claim 7, wherein the processor is configured to:
control the flow rate of the air using the machine learning model corresponding to the capturing condition specified from the acquired apparatus information.

9. The information processing system according to claim 6,
wherein the machine learning model is generated by performing learning using a combination of the captured image, a capturing condition specified from the apparatus information, and the determination result as learning data.

10. The information processing system according to claim 1, wherein the processor is configured to:
control the flow rate of the air using a predetermined threshold value for each capturing condition specified from the apparatus information.

11. The information processing system according to claim 10, wherein the processor is configured to:
calculate the threshold value by an interpolation calculation using a plurality of the threshold values.

12. A non-transitory computer readable medium storing a program executed by a computer that controls an image forming apparatus, the program causing the computer to realize:
a function of acquiring information representing a state of floating paper in a case where air is blown to a side surface of a bundle of the paper and apparatus information related to an apparatus that performs a predetermined process on the paper; and
a function of controlling a flow rate of the air based on the information representing the state and the apparatus information.

13. An information processing method comprising:
acquiring information representing a state of floating paper in a case where air is blown to a side surface of a bundle of the paper and apparatus information related to an apparatus that performs a predetermined process on the paper; and
controlling a flow rate of the air based on the information representing the state and the apparatus information.
